(19) United States
(12) Patent Application Publication
(10) Pub. No.: US 2026/0095997 A1
(43) Pub. Date: Apr. 2, 2026

(54) FIELD LIGHTING ACTIVATION SYSTEM

(71) Applicant: ABL IP Holding LLC, Atlanta, GA (US)

(72) Inventors: Christopher D. Nolan, Camillus, NY (US); Joseph R. Casper, Baldwinsville, NY (US)

(21) Appl. No.: 19/347,151

(22) Filed: Oct. 1, 2025

Related U.S. Application Data
(60) Provisional application No. 63/701,918, filed on Oct. 1, 2024.

(51) Int. Cl. H05B 47/175; G06K 7/14; G06Q 20/32; H04N 7/18; H04N 23/661; H04W 4/80; H05B 47/17

(52) U.S. Cl. CPC H05B 47/1965; G06K 7/1417; G06Q 20/3276; H04N 7/183; H04N 23/661; H04W 4/80; H05B 47/17

(57) ABSTRACT

A system for controlling lighting modules at an outdoor facility includes a server that will receive a service request from a mobile device. The request is triggered when the mobile device captures a barcode that is displayed at the facility. The mobile device will send user-selected operational parameters and payment information. In response, the server will generate a command to activate the lighting modules according to the operational parameters, and it will send the command to lighting modules. The lighting modules will operate according to the selected parameters. The server does not need to require any prior authorization from a user of the mobile device.

### RELATED APPLICATIONS AND CLAIM OF PRIORITY

This patent document claims priority to U.S. Patent Application No. 63/701,918, filed Oct. 1, 2024. The disclosure of the priority application is fully incorporated into this document by reference.

### BACKGROUND

Sports fields and parks, particularly public or community-owned fields and parks, face challenges in managing the use of lighting. Leaving lights on for extended periods incurs significant energy costs. Manually turning lighting systems on to ensure lighting is available at appropriate times requires significant personnel costs, and it also results in wasted energy because the lights are often turned on before they are needed and/or left on well past the conclusion of an event. While some systems are available that allow pre-authorized users to control lighting systems, these systems require significant infrastructure and resources to control user authorization. For example, they may require dedicated light activation kiosks at the facility. In addition, they may require users to maintain an account, download an app, and/or take other actions prior to activating the lighting. These systems also provide no means for managing energy usage at the facility, or for allowing a facility administrator to manage authorization of a system that is open to all users.

This document describes methods and systems that are directed to addressing at least some of the problems described above.

### SUMMARY

This document discloses systems and methods for activating outdoor lighting. More specifically, this document describes to a system integrated into a modular lighting system that allows visitors to a facility such as a sports field or court, park, or other outdoor recreational area to activate lighting in a target area of the facility for a specified period of time without setting up an account to become authorized by an operator of the target area to use the lighting service.

In some embodiments, a lighting system includes a group of lighting modules, along with a server comprising a processor and programming instructions. The server will receive a service request from a mobile electronic device. The request is triggered by the mobile electronic device capturing a barcode that is displayed at an outdoor facility at which the lighting modules are installed. The server will transmit, to the mobile electronic device for output on a user interface, available operational parameters for a selected lighting module that is associated with the barcode. In response to receiving, from the mobile electronic device, a selection of one or more of the available operational parameters and payment information, the server will generate a first command to activate the selected lighting module according to the selected one or more operational parameters. The server will then send the first command to the selected lighting module for controlling operation of the selected lighting module. The selected lighting module will use the command to operate according to the selected one or more operational parameters. The server does not require any prior authorization from a user of the mobile electronic device before transmitting the available operational parameters, generating the first command, or sending the first command.

Optionally, the system also may include additional programming instructions to cause the server to, in response to receiving the service request: (a) determine whether an administrator electronic device of the lighting system is exercising control of the selected lighting module at a time that the service request is received; and (b) only generate the first command to activate the selected lighting module after determining that the administrator electronic device is not exercising control of the selected lighting module at the time the service request is received.

Optionally, in any of the system embodiments listed above, the system also may include additional programming instructions to cause the server to, after sending the first command to the selected lighting module, and in response to receiving, from an administrator electronic device, an administrator request to exercise control of the selected one or more lighting modules: (a) generate a second command to operate the selected lighting module according to the administrator request; and (b) send the second command to the selected lighting module for controlling operation of the selected lighting module according to the administrator request instead of the selected operational parameters.

Optionally, in any of the system embodiments listed above, the programming instructions for the server to transmit, to the mobile electronic device, the available operational parameters may include instructions to identify scenes that are available for the selected lighting module, and to send operational parameters of the scenes to the mobile electronic device. In addition, the programming instructions for the server to generate the first command to activate the selected lighting module according to the selected one or more operational parameters may include instructions for the selected lighting module to trigger one of the scenes that is associated with the selected one or more operational parameters.

Optionally, in some embodiments that include the details of the previous paragraph, the system also may include the one or more lighting modules, each of which comprises: (a) a lighting support that holds one or more luminaires; and (b) a local controller stack that includes a power supply, control circuitry for controlling the one or more luminaires of the lighting module, and a memory device storing the scenes that are available to that lighting module.

Optionally, in any of the system embodiments listed above, the system also may include a camera. The programming instructions may then further cause the server to, in response to the selected lighting module being connected to the camera, transmit, to the mobile electronic device for output on the user interface, a user-selectable prompt to trigger operation of the camera. The programming instructions may then further cause the server to, in response to receiving, a user selection of the prompt from the mobile electronic device, include, with the first command, an additional command to operate the camera when activating the selected lighting module according to the selected one or more operational parameters. The camera will be operable to capture video footage of a target area that is illuminated by the selected lighting module in response to receiving the command to operate the camera.

Optionally, in any of the system embodiments listed above, each of the lighting modules comprises a local controller stack that includes: (a) a power supply for powering one or more luminaires of the lighting module; (b) a power monitor for measuring an amount of energy used by the one or more luminaires of the lighting module; (c) a communication circuit; (d) a local processor; and a memory containing programming instructions that will cause the local processor to, in response to receiving the first command, (i) receive, from the power monitor, a measurement of energy used by the one or more luminaires of the lighting module when operating according to the selected one or more operational parameters, and (ii) send the measurement of energy to the server.

Optionally, in any of the system embodiments listed above, the system also may include: (a) a plurality of the one or more lighting modules, each of which comprises a lighting support that holds one or more luminaires; and (b) a gateway controller that includes a processor and a wireless communication system. If so, the instructions to send the first command to the selected lighting module may include instructions to send the first command to the gateway controller for controlling operation of the selected lighting module.

Optionally, in any of the system embodiments listed above, the system also may include instructions cause the server to, in response to receiving the selection of one or more of the available operational parameters and payment information, communicate with a third-party service and cause the third-party service to send information to the selected lighting module for outputting while implementing the first command.

Optionally, in some embodiments that include the details of the previous paragraph, the third-party service comprises a severe weather service or emergency alert service that sends emergency signals to the selected lighting module. In addition, a local controller stack of the selected lighting module may include a memory storing a scene with parameters for changing light output by the selected lighting module in response to receiving an emergency signal. In addition, the emergency signal will, when received by the local controller stack, cause the local controller stack to implement the scene at the selected lighting module.

Other embodiments are directed a method of activating a lighting system, where the method includes, by a server, in response to receiving a service request from a mobile electronic device, wherein the service request was triggered by the mobile electronic device capturing a barcode that is displayed at an outdoor facility at which one or more lighting modules are present: (a) transmitting, to the mobile electronic device for output on a user interface, available operational parameters for a selected lighting module that is associated with the barcode; and (b) in response to receiving, from the mobile electronic device, a selection of one or more of the available operational parameters and payment information, (i) generating a first command to activate the selected lighting module according to the selected one or more operational parameters, and (ii) sending the first command to the selected lighting module for controlling operation of the selected lighting module. In this method the server does not require any prior authorization from a user of the mobile electronic device before transmitting the available operational parameters, generating the first command, or sending the first command.

Optionally, the method also may include, by the server in response to receiving the service request: (a) determining whether an administrator electronic device of the lighting system is exercising control of the selected lighting module at a time that the service request is received; and (b) only generating the first command to activate the selected lighting module after determining that the administrator electronic device is not exercising control of the selected lighting module at the time the service request is received.

Optionally, any of the method embodiments listed above also may include, by the server after sending the first command to the selected lighting module and in response to receiving, from an administrator electronic device, an administrator request to exercise control of the selected one or more lighting modules: (a) generating a second command to operate the selected lighting module according to the administrator request; and (b) sending the second command to the selected lighting module for controlling operation of the selected lighting module according to the administrator request instead of the selected operational parameters.

Optionally, in any of the method embodiments listed above, transmitting the available operational parameters to the mobile electronic device may include (i) identifying scenes that are available for the selected lighting module, and (ii) sending operational parameters of the scenes to the mobile electronic device. In addition, the first command to activate the selected lighting module according to the selected one or more operational parameters may, when implemented by the selected lighting module, cause the selected lighting module to trigger one of the scenes that is associated with the selected one or more operational parameters.

Optionally, in the method embodiment of the previous paragraph, the scenes may be stored in a memory device of a local controller stack that is included in the selected lighting module.

Optionally, in any of the method embodiments listed above, the server may transmit, to the mobile electronic device for output on a user interface, a user-selectable prompt to trigger operation of a camera that is connected to the selected lighting module. In response to receiving a user selection of the prompt from the mobile electronic device, the server may include, with the first command, an additional command to operate the camera when activating the selected lighting module according to the selected one or more operational parameters. In addition, in response to receiving the command to operate, the camera will capture video footage of a target area that is illuminated by the selected lighting module.

Optionally, in any of the method embodiments listed above, the server may receiving, from a local controller stack of the selected lighting module, a measurement of energy used by one or more luminaires of the lighting module when operating according to the selected one or more operational parameters. In in response to (a) an energy usage restriction being in place when receiving the measurement of energy and (b) the measurement of energy being higher than a threshold amount, the server may cause the lighting module to limit operation of the one or more luminaires.

Optionally, in any of the method embodiments listed above, sending the first command to the selected lighting module may comprise sending the first command to a gateway controller for controlling operation of the selected lighting module.

Optionally, in any of the method embodiments listed above, in response to receiving the selection of one or more of the available operational parameters and payment information, the server may communicate with a third-party service and cause the third-party service to send information to the selected lighting module for outputting while implementing the first command.

Optionally, in embodiments according to the previous paragraph, the third-party service may comprise a severe weather service or emergency alert service that sends an emergency signal to the selected lighting module. In addition, the selected lighting module may comprise a memory storing a scene with parameters for changing light output by the selected lighting module. The received emergency signal may, when received by the local controller stack, cause the selected lighting module to implement the scene at the selected lighting module.

Other embodiments are directed a computer program product comprising a non-transitory memory device storing programming instructions that will, upon execution, cause a processor to implement any of the method embodiments listed above.

### BRIEF DESCRIPTION OF THE DRAWINGS

FIG. 1 illustrates example elements of an outdoor lighting activation system.

FIG. 2 illustrates actions that may be implemented in a method of controlling activation of outdoor lighting.

FIG. 3 illustrates an example client electronic device user interface for controlling operation of outdoor lighting equipment.

FIG. 4 illustrates example elements of an administrator user interface.

FIG. 5 illustrates hardware components that a local controller stack of a lighting module may include.

FIG. 6 illustrates example components of an electronic device that may be used in an outdoor lighting activation system.

### DETAILED DESCRIPTION

In this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

Additional terms that are relevant to this disclosure will be defined at the end of this Detailed Description section.

This disclosure relates to methods and systems for activating outdoor lighting systems such as sports field and/or park lighting. Various embodiments include a system integrated into a modular sports lighting system that allows any person having an internet-connected mobile device who visits a sports field to initiate a lighting system at the field for a specified duration, without the need for pre-authorization. Additionally, in some embodiments the system may enable users to access additional functions such as camera footage of the field at which the luminaires of the lighting system are installed.

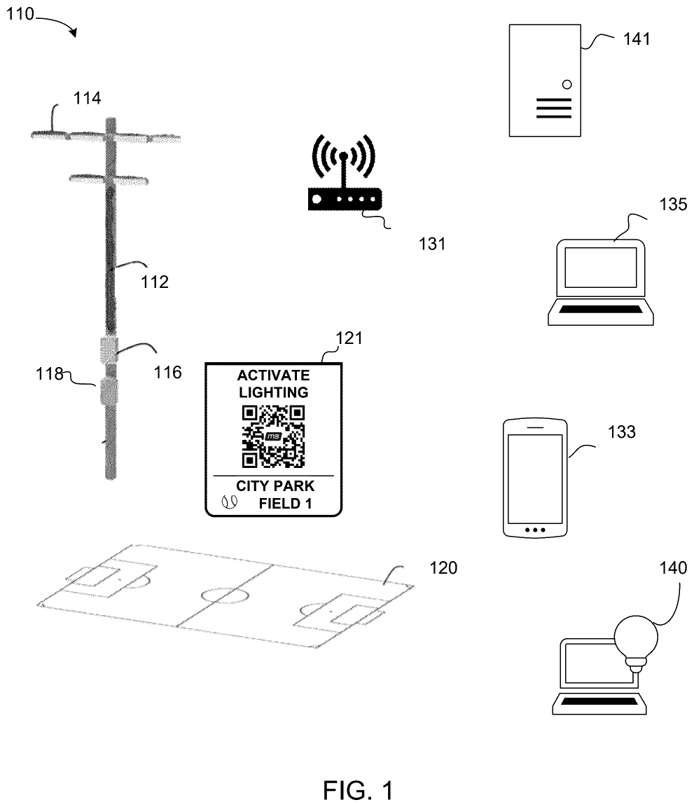

FIG. 1 illustrates example elements of an outdoor lighting activation system. The system includes one or more lighting modules 110, each of which comprises a lighting support 112 such as a pole, tower, stand, yoke mount, or other structure that holds, supports, and positions above ground one or more luminaires 114. Each luminaire 114 includes one or more groups of light emitting diode (LED) or other illumination-producing modules. The luminaires 114 may be arranged to extend laterally from the lighting support 112 as shown in FIG. 1, or they may be arranged in a different configuration.

A local controller stack 116 is attached to the lighting support 112 and includes one or more weather-resistant enclosures, each of which contains a power supply, control circuitry for controlling the one or more luminaires of the lighting module, and memory. Each local controller stack 116 transforms local electricity from alternating current (AC) to direct current (DCpower and includes LED drivers for operating the luminaires 114. The controller stack 116 may receive AC power from an external power source such as a power cable. The power supply may may transform the AC to DC for delivering DC to the luminaires 114 and/or a rechargeable battery. Optionally, the power supply may include a solar panel that transforms solar energy into DC for operating the luminaires 114 and/or charging the battery. Additional elements of an example local controller stack 116 are disclosed in FIGS. 15-19 and the corresponding description of U.S. Pat. No. 11,371,690, the disclosure of which is fully incorporated into this document by reference.

Each lighting module 110, when installed at a facility that includes a target area 120 of an outdoor facility such as a sporting field, pitch, park, amphitheater, or parking lot, will illuminate the target area 120 when activated. This document may use the term “field” generally to refer to any such outdoor target area that is illuminated by one or more lighting modules. Additional features about example lighting modules 110 will be described below and are also described in U.S. Pat. Nos. 11,371,690 and 12,104,777, the disclosures of which are fully incorporated into this document by reference.

In some embodiments, an environmental perception sensor 118 may be attached to the lighting module 110 and positioned to capture information about the target area 120. The sensor 118 may be attached to lighting support 112, any of the luminaires 114, and/or the local controller stack 116. The sensor 118 may include a camera, a radar system, a lidar system, or any combination of these.

In various embodiments, the system may include a gateway controller 131 that is positioned at the facility that includes the target area 120. The gateway controller 131 is an electronic device that is communicatively connected to each of the lighting modules 110 at the target area via a local area network, a wired or local wireless connection, or other communication system. The gateway controller 131 will include a processor and a memory, with programming that enables the gateway controller 131 to send commands to control the lighting modules 110 and communicate with other electronic devices of the system.

The system also may include a remote server 141 that is positioned either at the facility that includes the target area, or away from the facility at another location in a cloud-based arrangement. The remote server 141 may communicate directly with the lighting modules 110, or it may indirectly communicate with the lighting modules 110 by sending commands to and receiving information from the lighting modules 110 via the gateway controller 131, which will relay communications to and from the lighting modules 110.

A client mobile electronic device 133 will enable a user to control operation of the lighting modules 110 at the target area 120 using methods described in this document. The client mobile electronic device 133 will include: (a) a display; (b) a camera that can capture an image of a quick response (QR) code or other barcode 121 that is displayed by a sign, label, or display that is on or near the lighting module 110; (c) a browser or other software application that can access a site or portal hosted by the server 141 at an address contained in the barcode 121; and (d) communication hardware for communicating with the server 141 and/or the gateway controller 131.

An administrator electronic device 135 may be included and communicatively connected with the server 141 and/or the gateway controller 131. The administrator electronic device 135 will allow an authorized administrator such as an operator of the facility that includes the target area 120 to manage operation of the lighting modules 110 at the facility. While the administrator 135 must provide credentials indicating that the administrator is authorized to manage operation of the facility, a client mobile electronic device 133 will not necessarily need to provide credentials or other authorization in order to control one or more of the lighting modules 110.

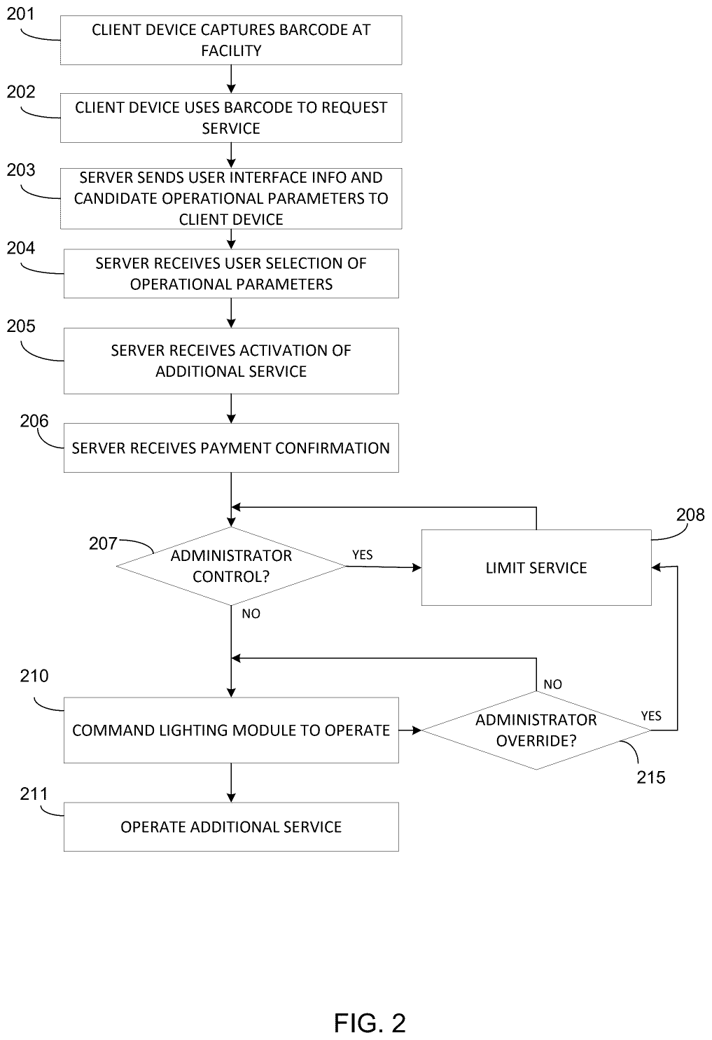

FIG. 2 illustrates methods by which the system will allow a user to control operation of one or more lighting modules at a facility. At 201 a client electronic device will capture an image of a barcode that is displayed on a sign, label, or display at a facility. The barcode will include an address of a server for a field lighting management service, optionally along with an identification code for the lighting module or modules at the facility to which the barcode is attached or to which the barcode is most proximate.

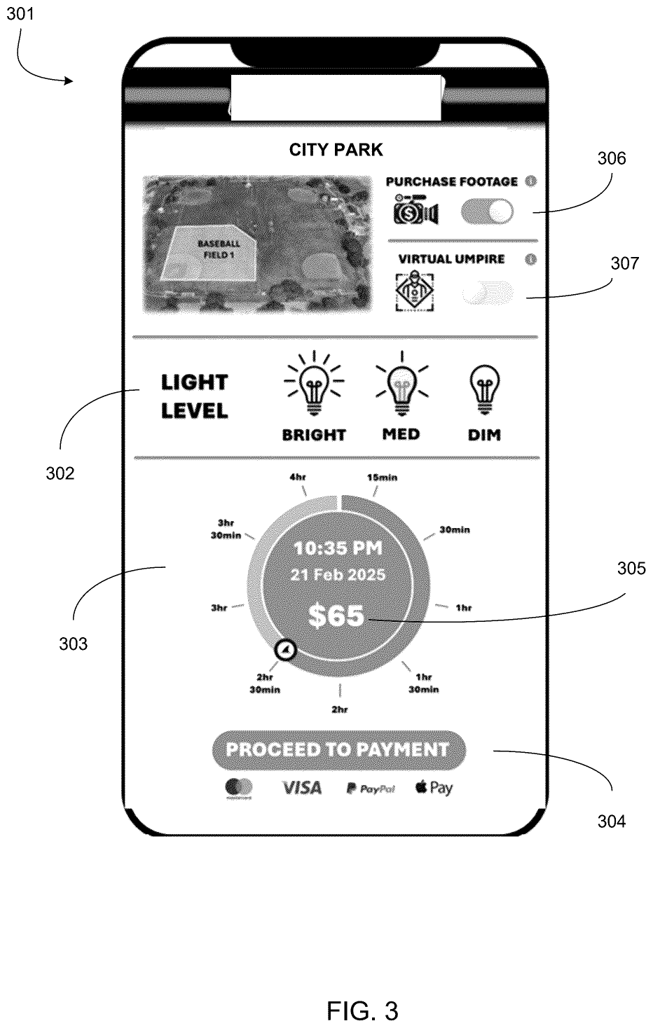

At 202 the client electronic device will decode the barcode to extract the address of the server from the barcode, and it will point a browser or other application to the address of the server to request the lighting service. This will cause the server to return, and the client electronic device to output, a lighting service user interface. An example user interface 301 will be described in more detail below in the discussion of FIG. 3. If the barcode includes an identification code for a particular lighting module or group of lighting modules (such as all lights that are directed to a particular sports field), the server may select and return information for that lighting module or group. Alternatively, the server may cause the user interface to output a set of candidate lighting modules, and a user of the client electronic device may select any of the candidate lighting modules for operation.

At 203, in response to the lighting service request, the server will transmit user interface information, such as a web page or data that an application installed on the client device that includes candidate operational parameters that a user of the client device may select for controlling operation of the lighting modules that are associated with the barcode. The candidate operational parameters may include, for example: (a) time of operation such as a start time, stop time, and/or duration; and/or (b) operational settings for the luminaires (such as brightness or color temperature). Examples of these are illustrated in FIG. 3, in which the candidate parameters include light level 302 and duration 303. Optionally, the operational parameters may be associated with one or more scenes, each of which is a group of operational parameters that a luminaire or set of luminaires may use to emit light over a period of time. A scene may remain static over the period of time, or it may change such as by causing the lights to flash, increase or reduce intensity, change colors, or otherwise change over time.

The user may use the client electronic device to select operational parameters from the candidate parameters, and at 204 the server will receive the selected operational parameters from the client device. At 206, the server may then wait for the client device to provide payment information (304 in FIG. 3) such as credit or debit card information, digital wallet information, payment application information, or other account information via which the user will pay the lighting service for activating the lighting modules. In response to receiving the operational parameters and payment information, at 210 the server will generate a command with instructions to automatically activate the selected lighting module or modules according to the selected operational parameters.

In some embodiments, at 205 the system may offer a user the ability to access one or more additional services to use additional, non-lighting equipment that is attached to the lighting modules while the lighting service is activated. For example, the user interface of FIG. 3 also indicates that the user interface may offer the user a video capture service 306, in which the ability to cause a camera that is attached to the lighting module (such as when sensor 118 of FIG. 1 is a camera) to capture video of the target area while the lights are implementing the user's request. If so, then in addition to generating the command for the lighting module to operate at 210, at 211 the server will also generate a command for the camera to capture a digital video concurrently with the lighting operation. The local controller stack of the lighting module will receive the digital video and send it to the server and/or the local gateway, which will store the digital video for retrieval and download by the user. The system may send the user a link to the storage location, or otherwise provide the user with access to the video, and the system may delete the video after the user retrieves it or after a threshold period of time has elapsed. The inclusion of video footage captured by a camera can increase users'interest in operating the system by allowing for the recording of activities that happen at the field during the purchased lighting session.

Additional services that the system may offer may include a virtual umpire service 307 which will use radar data the lighting module includes an attached radar system.

Optionally, some of the additional services available at 205 may include one or more remote, third-party services (140 in FIG. 1) may operate to send data to the local controller stack that speakers, microphones, and/or other hardware of the local controller stack may implement. Example remote, third-party services 140 include a severe weather alert service, a voice-triggered emergency service that will contact law enforcement or medical services in response to hearing a particular command phrase, and/or a streaming music service that may play audio via a speaker that is attached to the lighting module. Some such services (such as a streaming music service) may be available to the user for an additional fee. Other such services (such as severe weather and/or emergency services) may automatically be provided when the user purchases a lighting service, or a minimum level of service such as lighting for at least a threshold period of time. In embodiments that receive severe weather alerts and/or other emergency alerts from the third-party service 140, when operating the additional services at 211 the local controller may not only output an audio prompt of the alert, but it may also cause the lighting modules to implement a scene that is associated with the alert, such as one that causes the LEDs or other light-producing elements of luminaires to flash, change color, and/or change intensity.

As noted above, in some embodiments the operational parameters that are available for a user to select may be associated with one or more scenes for operating one or more luminaires over a period of time. In various embodiments, scenes that a particular lighting module can implement may be stored on the local controller stack of the lighting module. If so then when the server receives a service request for a lighting module, the server may: (a) access a data set that associates available scenes with lighting module; (b) retrieve, from the data set, the available scenes for the lighting module; and (c) present the user with operational parameters for those scenes. Then, when generating the command for the lighting module to operate, the server may generate instructions for the lighting module to trigger one of the scenes that corresponds to the user-selected operational parameters. By storing the scenes at the local controller stack, this can reduce latency in communication since it only requires a limited initial command to activate the scene, and it does not require the lighting module to maintain any communication with the server during operation.

Notably, the processes described above do not necessarily require the user to set up an account, download a dedicated application, or otherwise be authorized to operate the lighting modules. Instead, the user simply needs to be present at the facility with a mobile electronic device that can capture the barcode, select time or other parameters for operation, and provide payment. This provides advantages over prior systems that either restrict usage to authorized users, or which require specialized hardware such as lighting activation kiosks at the facility.

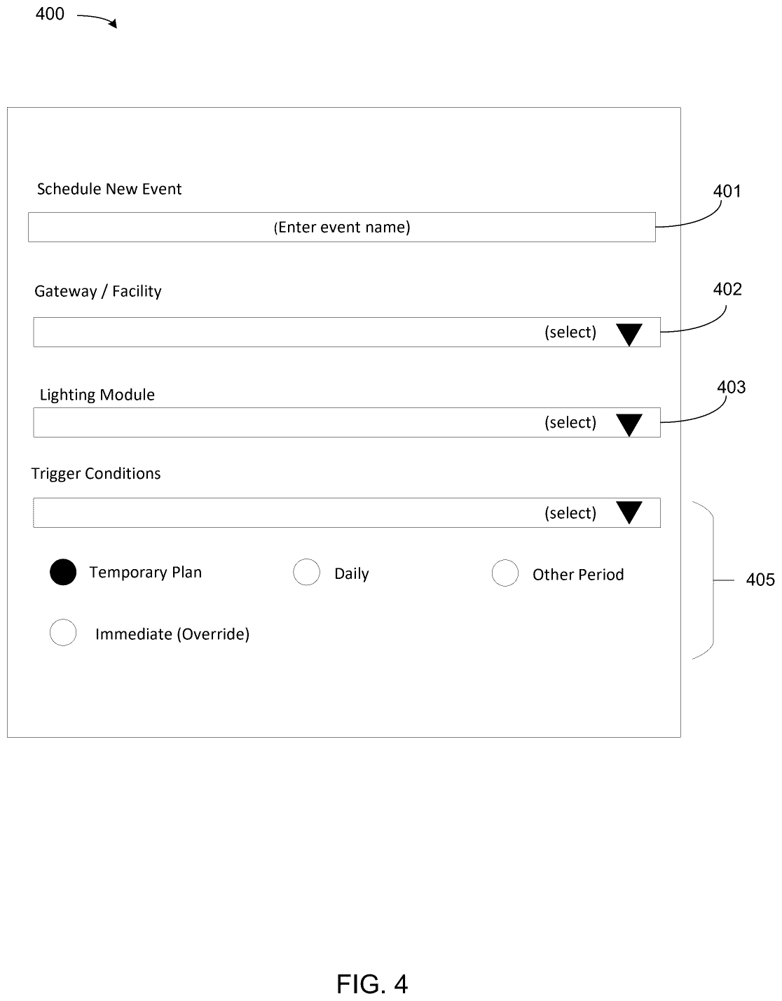

However, the system still provides security and management capabilities by allowing an administrator to limit or override actions that any of the lighting modules may perform at given periods of time. The administrator electronic device 135 will output an administrator user interface by which the administrator may exercise control over lighting systems and limit individual user activations. FIG. 4 illustrates example elements of one screen of an administrator user interface 400. The system may only allow the administrator user interface to operate on the administrator electronic device after the system receives an administrator credential such as username and password, biometric identifier, or other required authorization token. The user interface may include user-selectable fields by which administrators may define and schedule events 401 to take place at a facility. An event will include an identifier for a facility and/or gateway controller of a facility 402, one or more lighting modules 403 at the facility, and operational parameters 405 for the event such as what condition will trigger the event, whether the event is temporary or recurring, and/or whether the event will be scheduled at a particular time.

Returning to FIG. 2, if an administrator has scheduled an event at the facility, then before causing the lighting modules to implement the user's request at 210, at 207 the system will first determine whether an administrator is exercising control over the user-selected lighting modules such that the user's request conflicts with the administrator's scheduled event. If there is a conflict, such as if an event is scheduled at the present time or during the user's requested duration of operation (207: YES), then at 208 the system will limit the service that the user can receive. For example, the system may prevent any change in operation of the lighting system, or any lighting modules that are part of the event, by not sending operational commands to implement the user's request until the event is complete.

In addition, during a time when the system is causing lighting modules to operate according to user requests, if the system receives an override request (215: YES) from an administrator computing device, it may limit the service 208 as shown above until an event associated with the override request is complete. To do this, the system may generate and send a command to the lighting modules to operate according to the administrator request instead of the user-selected operational parameters.

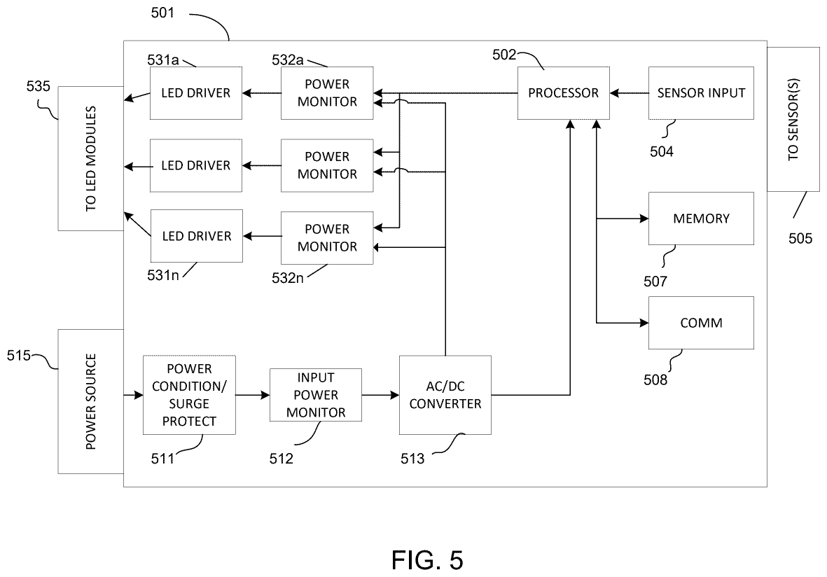

In various embodiments, as noted above each lighting module includes comprises a local controller stack. FIG. 5 illustrates example elements of a local controller stack. The elements shown in FIG. 5 may be contained in a single enclosure 501 or distributed among multiple enclosures. The local controller stack's processor 502 will use programming instructions stored in memory a 507, sensor data received from one or more external sensors 505 such as a camera or radar system via a sensor input 504, and commands and parameters received from external devices (such as a server or gateway controller) via a communication circuit 508 such as a communications port or receiver to generate signals that include commands will cause light-emitting modules, such as LED modules 535, of the luminaires to operate. Each LED module may have an associated LED driver 531a . . . 531n that will receive the signals, along with power from the local controller stack's power circuit, to operate the LED modules.

The power circuit may include a power conditioning and/or surge protection circuit 511 with components such as an electromagnetic interference (EMI) filter. An AC/DC converter 513 will convert AC received from an external power source 515 to DC. In addition or alternatively, a DC/DC converter may convert DC received from a battery or other power source to a level that will operate the LED drivers. The power circuit will deliver electricity to each LED driver 531a . . . 531n for powering the LED modules 535.

Each conductive path leading from the power circuit to an LED driver may include an energy usage sensor 532a . . . 532n that serves as a power monitor to measure the energy used by each LED module. Example power monitors include current sensors, current transformer (CT) sensors, voltage transformers, and watt meters. Optionally, the power circuit also may include a master energy sensor that serves as an overall input power monitor 512 to measure energy used by all LED modules that the local controller stack operates. When the processor receives, from any of the power monitors, a measurement of energy used by the one or more luminaires of the lighting module when operating according to the selected one or more operational parameters, the processor 502 will send the measurement of energy to the server via the communication circuit 508.

Optionally, the administrator electronic device and/or server may use the energy measurements to control various aspects of operation of the system. For example, returning to FIG. 2, when the server receives a lighting service request, the server may access real-time energy price information, and the server may calculate a cost for the requested lighting service that is a function of the real-time energy price. For example, if the time of the lighting service request is associated with a time when the real-time energy price is higher or lower than a baseline energy price, the server may modify the cost by multiplying it by an adjustment factor that is a function of the difference between the real-time energy price and the baseline energy price. In addition, if time of the lighting service request coincides with a time at which an energy usage restriction is in place, the system may apply administrator control at 207 to reduce energy used by the LED modules if the measured energy is higher than a threshold amount, such as within a minimum distance from a peak energy level. Options for reducing energy may be to limit the requested service at 208 by reducing brightness of the LEDs, permitting only a subset of the LEDs to operate, or restricting access to additional functions such as cameras or loudspeakers that are attached to the lighting modules.

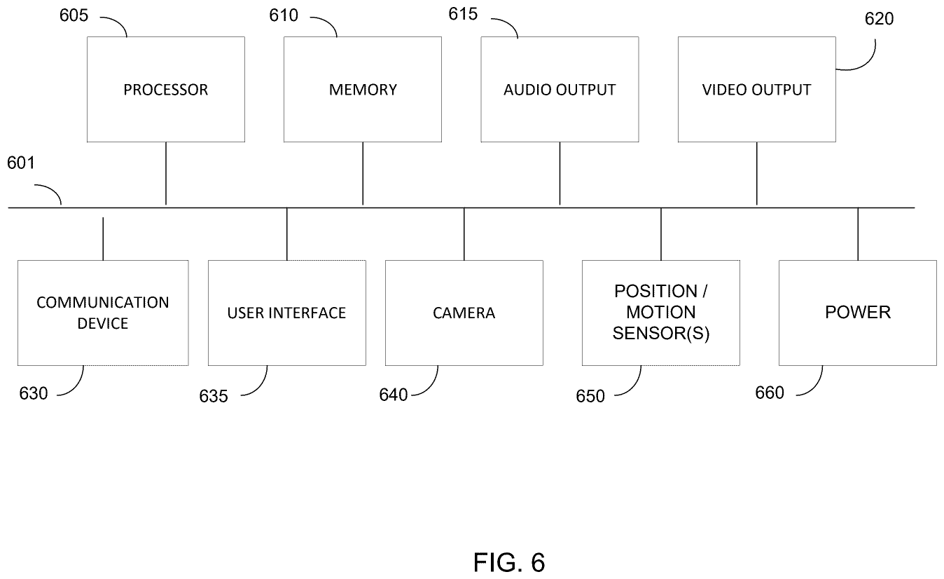

FIG. 6 depicts an example of internal hardware that may be included in any of the electronic devices of the system, such as the client mobile electronic device, administrator electronic device, server, and/or local controller stack. A conductive path such as that of one or more circuit boards 601 serves as a communication path via which messages, instructions, data, or other information may be shared among the other illustrated components of the hardware. Processor 605 is a central processing device of the system, configured to perform calculations and logic operations required to execute programming instructions. A memory 610 is a non-transitory device or collection of devices across which data and/or instructions are stored.

The electronic device may display information processed by the processor 605 on a video output device 620 (i.e., a display device) in visual, graphic, and/or alphanumeric format. Example video output devices include display screens, heads-up displays such as those used in virtual reality and augmented reality devices, projection devices, and video output ports such as HDMI ports that transfer information to an external display device. An audio output device 615 such as a speaker, video output port, or wireless transceiver such as those that operate via a Bluetooth® or other wireless communication protocol. Communication with external displays, audio outputs, and electronic device also may occur using various communication circuit devices 630 such as a wireless antenna, a radio frequency identification (RFID) tag and/or short-range or near-field communication transceiver, each of which may optionally communicatively connect with other components of the electronic device. The communication circuit devices 630 may be configured to be communicatively connected to a communications network, such as the Internet, a local area network or a cellular telephone data network.

The electronic device also may also include a user interface device 635 that includes one or more input devices that can receive data and/or commands from a user. Example user interface devices 635 include a keyboard, a mouse, touchscreen that is part of a display device of the video output 620, a touch pad, a remote control, a pointing device, and/or a microphone.

A camera 640 will include image sensors and other hardware that can capture video and/or still images.

The electronic device also may include one or more positional and/or motion sensors 650 that can detect position and movement of the device. Examples of motion sensors include gyroscopes, accelerometers, and inertial measurement units (IMUs). Examples of positional sensors include a global positioning system (GPS) sensor device that receives positional data from an external GPS network.

The electronic device also will include a power module 660 that, in operation, will provide power to the other components of the electronic device. The power module 660 may include an internal battery, a power port that will receive power when electrically connected to an external power source, a power management integrated circuit (PMIC), a DC-to-DC converter or AC-to-DC converter, a receiving coil for inductive charging, other power circuit components, and/or a combination of any of these.

Based on the teachings contained in this disclosure, it will be apparent to persons skilled in the relevant art(s) how to make and use embodiments of this disclosure using data processing devices, computer systems and/or computer architectures other than that shown in FIG. 6.

Methods and systems described in this document can provide several advantages over prior systems, such as: energy efficiency because lights are only turned on when needed, reducing unnecessary energy consumption; cost recovery because facility operators can offset the cost of lighting by charging users for their usage; user convenience because the barcode payment system is fast and easy for users, removing the need for dedicated kiosks or user account creation; and flexible usage because users can activate lighting as needed, making a field more accessible for evening games, practices, or impromptu gatherings.

In some embodiment, the client electronic device may include a mobile application integrated with multiple payment gateways (e.g., credit card, mobile wallet) to process payments after scanning the barcode. Upon completion of payment, a signal is sent via wireless or wired communication to the server, which will generate the commands required to activate the lighting module for a predefined period. Users can extend the lighting by repeating the payment process.

Additionally, integrated cameras capture footage of activities on the field during the lighting period. Users can choose to purchase access to this footage, either live or after the session, enhancing the value of the experience. Footage could be used for personal review, sharing on social media, or for team documentation.

The system is adaptable to various field types, such as baseball, soccer, football, or tennis/pickleball/paddle tennis courts, The system can be used with local power grids or solar-powered lighting setups. Administrative access allows operators to set pricing tiers based on usage times (e.g., discounted rates for off peak hours) and monitor energy consumption remotely.

In addition to the patents incorporated by reference above, this patent document also incorporates the disclosures of the following patents by reference in their entirety: U.S. Pat. Nos. 11,644,193; 11,209,153; and 11,284,492.

The following paragraphs provide additional information about various terms used in this document:

In this document, when terms such as “first” and “second” are used to modify a noun, such use is simply intended to distinguish one item from another and is not intended to require a sequential order unless specifically stated.

The term “approximately” when used in connection with a numeric value, is intended to include values that are close to, but not exactly, the number. For example, in some embodiments, the term “approximately” may include values that are within +/−10 percent (or, in some embodiments, +/−5 percent, +/−3 precent, or +/1 percent) of the value.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

In this document, the term “connected,” when referring to two physical structures, means that the two physical structures touch each other. Devices that are connected may be secured to each other, or they may simply touch each other and not be secured.

In this document, the term “electrically connected,” when referring to two electrical components, means that a conductive path exists between the two components. The path may be a direct path, or an indirect path through one or more intermediary components.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual or augmented reality devices, Internet-connected wearables such as smart watches and smart eyewear, personal digital assistants, cameras, tablet computers, laptop computers, media players and the like. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 6.

The terms “processor,” “processing device,” and “controller” refer to electronic device hardware that is configured to execute programming instructions. These terms may refer to a single processing device or any number of processing devices in a set of processors that collectively perform a set of operations. Thus, unless the context specifically states that a single processor or controller is required or that multiple processors or controllers are required, the terms “processor” and “controller” include both the singular and plural embodiments. Example processing devices include, a central processing unit (CPU), a graphics processing unit (GPU), a remote server, or a combination of these.

The terms “memory,” “memory device,” “computer-readable medium,” and “data store” each refer to a non-transitory device on which computer-readable data, programming instructions or both are stored. Read only memory (ROM), random access memory (RAM), flash memory, hard drives and other devices capable of storing electronic data constitute examples of memory devices. A “computer program product” is a combination of a memory device and the programming instructions stored in it. Unless the context specifically states that a single device is required or that multiple devices are required, the terms defined in this paragraph include both the singular and plural embodiments, as well as portions of such devices such as memory sectors.

A “server” is a computing device that includes one or more processors and one or more memory devices.

In this document, the terms “communication link,” “communication path,” and “communication circuit” mean a wired or wireless path or paths and associated hardware via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, a network may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method.

In this document, the term “camera,” when used in connection with a camera of a mobile electronic device generally refers to a hardware sensor that can acquire digital images. A camera may capture still and/or video images, and optionally may be used for other imagery-related applications. For example, a camera can be held by a user such as a DSLR (digital single lens reflex) camera, cell phone camera, or video camera. The camera may be part of an image capturing system that includes other hardware components.

The term “barcode”refers to a pattern or symbol that contains encoded data. Barcodes may include one-dimensional barcodes, two-dimensional barcodes (such as matrix codes, Quick Response (QR) codes, Aztec codes and the like), or three-dimensional barcodes.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

1. A lighting system, comprising:
a server comprising a processor and programming instructions that will, upon execution, cause the server to, in response to receiving a service request from a mobile electronic device, wherein the service request is triggered by the mobile electronic device capturing a barcode that is displayed at an outdoor facility at which one or more lighting modules are present:
transmit, to the mobile electronic device for output on a user interface, available operational parameters for a selected lighting module that is associated with the barcode; and
in response to receiving, from the mobile electronic device, a selection of one or more of the available operational parameters and payment information:
generating a first command to activate the selected lighting module according to the selected one or more operational parameters, and
sending the first command to the selected lighting module for controlling operation of the selected lighting module,
wherein the server does not require any prior authorization from a user of the mobile electronic device before transmitting the available operational parameters, generating the first command, or sending the first command.

2. The system of claim 1, further comprising additional programming instructions to cause the server to, in response to receiving the service request:
determine whether an administrator electronic device of the lighting system is exercising control of the selected lighting module at a time that the service request is received; and
only generate the first command to activate the selected lighting module after determining that the administrator electronic device is not exercising control of the selected lighting module at the time the service request is received.

3. The system of claim 1, further comprising additional programming instructions to cause the server to, after sending the first command to the selected lighting module:
in response to receiving, from an administrator electronic device, an administrator request to exercise control of the selected one or more lighting modules:
generate a second command to operate the selected lighting module according to the administrator request; and
send the second command to the selected lighting module for controlling operation of the selected lighting module according to the administrator request instead of the selected operational parameters.

4. The system of claim 1, wherein:
the programming instructions for the server to transmit, to the mobile electronic device, the available operational parameters comprise instructions to:
identify scenes that are available for the selected lighting module, and
send operational parameters of the scenes to the mobile electronic device; and
the programming instructions for the server to generate the first command to activate the selected lighting module according to the selected one or more operational parameters comprise instructions for the selected lighting module to trigger one of the scenes that is associated with the selected one or more operational parameters.

5. The system of claim 4, further comprising the one or more lighting modules, each of which comprises:
a lighting support that holds one or more luminaires; and
a local controller stack that includes a power supply, control circuitry for controlling the one or more luminaires of the lighting module, and a memory device storing the scenes that are available to that lighting module.

6. The system of claim 1, further comprising:
a camera,
wherein the programming instructions will further cause the server to, in response to the selected lighting module being connected to the camera:
transmit, to the mobile electronic device for output on the user interface, a user-selectable prompt to trigger operation of the camera; and
in response to receiving, a user selection of the prompt from the mobile electronic device, include, with the first command, an additional command to operate the camera when activating the selected lighting module according to the selected one or more operational parameters, and
wherein the camera is operable to capture video footage of a target area that is illuminated by the selected lighting module in response to receiving the command to operate the camera.

7. The system of claim 1, wherein each of the lighting modules comprises a local controller stack that includes:
a power supply for powering one or more luminaires of the lighting module;
a power monitor for measuring an amount of energy used by the one or more luminaires of the lighting module;
a communication circuit;
a local processor; and
a memory containing programming instructions that will cause the local processor to, in response to receiving the first command:
receive, from the power monitor, a measurement of energy used by the one or more luminaires of the lighting module when operating according to the selected one or more operational parameters, and
send the measurement of energy to the server.

8. The system of claim 1, further comprising:
a plurality of the one or more lighting modules, each of which comprises a lighting support that holds one or more luminaires; and
a gateway controller, which comprises a processor and a wireless communication system,
wherein the instructions to send the first command to the selected lighting module comprise instructions to send the first command to the gateway controller for controlling operation of the selected lighting module.

9. The system of claim 1, wherein the programming instructions further comprise instructions to, in response to receiving the selection of one or more of the available operational parameters and payment information, communicate with a third-party service and cause the third-party service to send information to the selected lighting module for outputting while implementing the first command.

10. The system of claim 9, wherein:
the third-party service comprises a severe weather service or emergency alert service that sends emergency signals to the selected lighting module;
the selected lighting module comprises a local controller stack that includes a memory storing a scene with parameters for changing light output by the selected lighting module in response to receiving an emergency signal; and
the emergency signal will, when received by the local controller stack, cause the local controller stack to implement the scene at the selected lighting module.

11. A method of activating a lighting system, the method comprising:
by a server, in response to receiving a service request from a mobile electronic device, wherein the service request was triggered by the mobile electronic device capturing a barcode that is displayed at an outdoor facility at which one or more lighting modules are present:
transmitting, to the mobile electronic device for output on a user interface, available operational parameters for a selected lighting module that is associated with the barcode, and
in response to receiving, from the mobile electronic device, a selection of one or more of the available operational parameters and payment information:
generating a first command to activate the selected lighting module according to the selected one or more operational parameters, and
sending the first command to the selected lighting module for controlling operation of the selected lighting module,
wherein the server does not require any prior authorization from a user of the mobile electronic device before transmitting the available operational parameters, generating the first command, or sending the first command.

12. The method of claim 11 further comprising, by the server in response to receiving the service request:
determining whether an administrator electronic device of the lighting system is exercising control of the selected lighting module at a time that the service request is received; and
only generating the first command to activate the selected lighting module after determining that the administrator electronic device is not exercising control of the selected lighting module at the time the service request is received.

13. The method of claim 11, further comprising:
by the server after sending the first command to the selected lighting module and in response to receiving, from an administrator electronic device, an administrator request to exercise control of the selected one or more lighting modules:
generating a second command to operate the selected lighting module according to the administrator request; and
sending the second command to the selected lighting module for controlling operation of the selected lighting module according to the administrator request instead of the selected operational parameters.

14. The method of claim 11, wherein:
transmitting the available operational parameters to the mobile electronic device comprises:
identifying scenes that are available for the selected lighting module, and
sending operational parameters of the scenes to the mobile electronic device; and
the first command to activate the selected lighting module according to the selected one or more operational parameters will, when implemented by the selected lighting module, cause the selected lighting module to trigger one of the scenes that is associated with the selected one or more operational parameters.

15. The method of claim 14, wherein the scenes are stored in a memory device of a local controller stack that is included in the selected lighting module.

16. The method of claim 11, further comprising:
by the server:
transmitting, to the mobile electronic device for output on a user interface, a user-selectable prompt to trigger operation of a camera that is connected to the selected lighting module, and
in response to receiving a user selection of the prompt from the mobile electronic device, including, with the first command, an additional command to operate the camera when activating the selected lighting module according to the selected one or more operational parameters, and
by the camera in response to receiving the command to operate the camera, capturing video footage of a target area that is illuminated by the selected lighting module.

17. The method of claim 11, further comprising, by the server:
receiving, from a local controller stack of the selected lighting module, a measurement of energy used by one or more luminaires of the lighting module when operating according to the selected one or more operational parameters, and
in response to an energy usage restriction being in place when receiving the measurement of energy and the measurement of energy being higher than a threshold amount, causing the lighting module to limit operation of the one or more luminaires.

18. The method of claim 11, wherein sending the first command to the selected lighting module comprises sending the first command to a gateway controller for controlling operation of the selected lighting module.

19. The method of claim 11 further comprising, by the server in response to receiving the selection of one or more of the available operational parameters and payment information, communicating with a third-party service and causing the third-party service to send information to the selected lighting module for outputting while implementing the first command.

20. The method of claim 19, wherein:
the third-party service comprises a severe weather service or emergency alert service that sends an emergency signal to the selected lighting module;
the selected lighting module comprises a memory storing a scene with parameters for changing light output by the selected lighting module; and
the received emergency signal will, when received by the local controller stack, cause the selected lighting module to implement the scene at the selected lighting module.

21. A computer program product comprising a non-transitory memory device storing programming instructions that will, upon execution, cause a processor to:
in response to receiving a service request from a mobile electronic device, wherein the service request was triggered by the mobile electronic device capturing a barcode that is displayed at an outdoor facility at which one or more lighting modules are present:
transmit, to the mobile electronic device for output on the user interface, available operational parameters for a selected lighting module that is associated with the barcode; and
in response to receiving, from the mobile electronic device, a selection of one or more of the available operational parameters and payment information:
generate a first command to activate the selected lighting module according to the selected one or more operational parameters, and
send the first command to the selected lighting module for controlling operation of the selected lighting module,
wherein the processor does not require any prior authorization from a user of the mobile electronic device before transmitting the available operational parameters, generating the first command, or sending the first command.
